(19) United States
(12) Patent Application Publication
(10) Pub. No.: US 2018/0154566 A1
(43) Pub. Date: Jun. 7, 2018

(54) PROCESS, APPARATUS AND SYSTEM FOR CREATING EXTRUDED PLASTIC SHEETS HAVING DECORATIVE EFFECTS, PRODUCTS MADE WITH EXTRUDED PLASTIC SHEETS CREATED WITH SAME AND DECORATIVE FILMS FOR USE IN SUCH PROCESS, APPARATUS AND SYSTEM

(71) Applicant: PELICAN INTERNATIONAL INC., Laval (CA)

(72) Inventors: Marie MATET, Montreal (CA); Philippe LEBLANC, Montreal (CA)

(21) Appl. No.: 15/830,903

(22) Filed: Dec. 4, 2017

Related U.S. Application Data
(60) Provisional application No. 62/430,061, filed on Dec. 5, 2016.

(51) Int. Cl. B29C 47/00; B29C 47/06; B29C 65/78; B29C 65/48; B29C 65/02; B29C 65/00; B29C 51/00; B29C 51/14; B32B 7/12; B32B 27/08; B32B 37/06; B32B 37/12; B32B 27/30; B32B 27/32

(52) U.S. Cl. CPC B29C 47/0064; B29K 2105/256; B29C 47/065; B29C 65/7894; B29C 65/483; B29C 65/02; B29C 66/83413; B29C 51/002; B29C 51/14; B29C 47/0066; B32B 7/12; B32B 27/08; B32B 37/06; B32B 37/12; B29C 47/0054; B32B 27/304; B32B 27/32; B29C 47/004

(57) ABSTRACT

A system and associated process for creating an extruded sheet having a decorative surface effect, such as plastic for example are presented. A roll of decorative plastic film for use in such system and process is also presented. Viscous materials are provided and fed through an extruder module and feed block to form a stream of viscous material. A die positioned downstream forms the stream of viscous material into a sheet of material and a calander having a set of rolls smoothes the sheet of material after it is released by the die. A film application assembly cooperates with the calander to apply a decorative plastic film to a surface of the sheet of material. The film application assembly includes a support structure for holding a roll of the decorative plastic film and a film feeding mechanism configured to direct the decorative plastic film to position a surface of the decorative plastic film opposite the surface of the sheet of material. The sheet of material to which the decorative plastic film has been applied is then directed towards an accumulation area. Sheets of extruded material having decorative surface effect may be created using such process/system and may be used in the manufacturing of many different products including for example kayaks, stand-up paddle boards, luges amongst many others. The process and system described here may be used alone, in combination with other processes and systems, for creating visually pleasing effects in extruded materials.

### CROSS-REFERENCE TO RELATED APPLICATIONS

The present application claims the benefit of priority under 35 USC § 119(e) based on U.S. provisional patent application Ser. No. 62/430,061 filed on Dec. 5, 2016. The contents of the above-referenced patent document are incorporated herein by reference.

### FIELD OF THE INVENTION

The present invention relates generally to the field of extrusion processes and extruded plastic sheets created using such processes. More specifically, the present invention relates to processes and associated apparatuses and systems for creating extruded plastic sheets having decorative effects created at least in part using decorative films as well as to products made with extruded plastic sheets having decorative effects created using such processes. The invention also extends to various specific decorative films that may be used to create extruded plastic sheets having decorative effects.

### BACKGROUND

Extrusion processes are commonly used in a variety of different industries, and with a multitude of different types and grades of material, for forming and shaping these materials into articles.

Extruded products, whether plastic, metal or some other material, are often uniform in color. In some cases, the extruded products are formed of several layers of material, including one or more visible, outer layers and one or more hidden, inner layers, where these layers may differ in color.

In today's competitive market place, it is important for companies to have an edge that distinguishes their product from a competitor's product. One way to create a product that distinguishes itself from a competitor's product is to provide the product with an aesthetically pleasing and/or original appearance. Consumers are typically attracted to products having a visually appealing look.

In the field of extruded products, one method for giving the end products a visually appealing look is to create special decorative effects in the material used to make the product.

Some methods for producing decorative effects in extruded material, such as plastic sheets for example, allow producing color effects by combining flows of viscous material of multiple colors during the extrusion process. For examples of such methods the reader is invited to refer to U.S. Pat. No. 7,204,944 issued on Apr. 17, 2003 and to U.S. patent application Ser. No. 14/757,943 filed on Dec. 23, 2015 and published under U.S. patent publication No. US-2017-0182697-A1 on Jun. 29, 2017. The contents of the aforementioned documents are incorporated herein by reference. While approaches of the type described in the above documents may allow creating extruded material having a pleasing and original visual appearance, the decorative effects that may be produced using such approaches tend to provide only limited control on the final visual effects that may be produced. For example, while such approaches allow creating pleasing color patterns and fading features, they tend not to allow creating a material with specific graphical ornamental elements.

In order to address deficiencies linked to the creation of decorative effects using extrusion processes alone, other techniques have been proposed which include lamination and imprinting techniques. Lamination techniques typically include joining multiple different layers of colored material together to form a multi-colored sheet. Imprinting techniques typically include the use of an imprinted film bearing a design decorative pattern that is adhered to a surface of an extruded material as a skin or overlay. Lamination and imprinting techniques typically provide manufacturers with increased control over the final decorative effects that may be produced on a plastic sheet. Unfortunately, most conventional lamination and imprinting processes tend to be costly, complex and time consuming rendering them impractical for most wide-scale commercial applications.

It remains however desirable to create extruded plastic sheets having decorative effects that may differ from those that may be created by methods of the type proposed in the past and/or that may provide increase control on resulting decorative effects that may be achieved.

### SUMMARY

In accordance with a first general aspect, a system for creating an extruded sheet having a decorative surface effect is provided. The system comprises:
a) an extruder module for providing a viscous material;
b) a feed block module positioned downstream from the extruder for receiving the viscous material and releasing a stream of viscous material;
c) a die positioned downstream from the feed block module for forming said stream of viscous material into a sheet of material;
d) a calander having a set of rolls positioned downstream from the die for smoothing the sheet of material after it is released by the die, in use the sheet of material released by the die being feed through the set of rolls of the calander in a specific sheet feed order, said set of rolls being configured for affecting a temperature of the sheet of material;
e) a film application assembly including modules configured to cooperate with the calander for applying a decorative plastic film to a surface of the sheet of material, wherein said film application assembly includes:
   i) a support structure for holding a roll of the decorative plastic film; and
   ii) a film feeding mechanism configured to direct the decorative plastic film to position a surface of the decorative plastic film opposite the surface of the sheet of material;
f) an output assembly downstream from the calander for directing the sheet of material to which the decorative plastic film has been applied towards an accumulation area.

In some specific implementations, the system is configured to operate on viscous material that may be a viscous plastic material. For example, the viscous plastic material may be formed of at least one of: polyethylene (PE), polypropylene (PP), acetal, acrylic, nylon (polyamides), polystyrene, polyvinyl chloride (PVC), acrylonitrile butadiene styrene (ABS) and polycarbonate. In a very specific practical implementation, the viscous plastic material may be formed of high density polyethylene (HDPE).

In some specific implementations, the film feeding mechanism includes positioning members for directing the decorative plastic film between adjacent rolls in the set of rolls of the calander, the adjacent rolls being configured to urge the surface of the decorative plastic film toward the opposed surface of the sheet of material to bond the decorative plastic film to the sheet of material. In some specific practical implementations, the positioning members of the film feeding mechanism may include positioning rolls. Alternatively, or in addition, the film feeding mechanism may include pressure rolls positioned downstream from the calander to urge the surface of the decorative plastic film toward the opposed surface of the sheet of material to bond the decorative plastic film to the sheet of material.

In some specific practical implementations, the decorative plastic film may be either thermally bonded or chemically bonded to the sheet of material or may be both thermally and chemically bonded thereto.

In some specific practical implementations, the modules of the film application assembly may be configured to cooperate with the calander for applying the decorative plastic film to cause the decorative plastic film to be thermally bonded to the sheet of material, wherein the film application assembly includes modules for heating the decorative plastic film and/or the sheet of material to a suitable temperature to cause the decorative plastic film to be thermally bonded to the sheet of material. Alternatively, or in addition, the modules of the film application assembly may be configured to cooperate with the calander for applying the decorative plastic film to cause the decorative plastic film to be chemically bonded to the sheet of material. This may be affected by activating an adhesive substance (e.g. glue) previously applied to a surface of the decorative plastic film and/or by providing an automated mechanism for applying an adhesive substance (e.g. glue) to a surface of the plastic film before the plastic film is brought into contact with the sheet of material.

In accordance with some specific implementations, the film feeding mechanism is configured to cooperate with the calander to direct the decorative plastic film through the rolls of the calander in a specific film feed order. In a first specific example, the specific sheet feed order and the specific film feed order may be characterized by a same or a different sequence of pairs of adjacent rolls between which the sheet of material and the plastic film are fed. For example, a specific sequence of pairs of adjacent rolls of the calander between which the sheet of material is fed may include one or more pairs of adjacent rolls which are omitted from the specific sequence of pairs of adjacent rolls between which the plastic film is fed.

In accordance with some specific implementations, at least some rolls in the set of rolls of the calander may be configured for affecting a temperature of the sheet of material by cooling the temperature of the sheet of material to no more than between about 250° F. and about 450° F. to allow the decorative plastic film to thermally bond with the sheet of material. The specific manner in which the rolls of the calander may cool the sheet of material may vary between implementations and may include, without being limited to, liquid cooling (e.g. by circulating water and/or a coolant having temperature within a specific temperature range in piping in are in an area adjacent to the rolls) and air cooling (ventilation).

In addition, in accordance with some specific implementations, at least some rolls in the set of rolls of the calander may be configured for affecting a temperature of the sheet of material by cooling the temperature of a portion of the sheet of material to which the decorative plastic film has already been applied to below 200° F., and preferably in some cases to below 115° F., so as to prevent the sheet of material from adhering to other similarly produced sheets of material.

In accordance with some specific implementations, at least some rolls in the set of rolls may have a textured outer surface configured for imparting a three-dimensional texture on the surface of the sheet of material to which the decorative plastic film is applied, textured outer surface of the at least some rolls including projections for created the three-dimensional texture on the surface of the sheet of material. In specific practical implementations in which the decorative plastic film includes one or more graphical elements, the textured outer surface of the rolls may be configured to complement the one or more graphical elements of the decorative plastic film. In a non-limiting specific example, the one or more graphical elements of the decorative plastic film may convey images of wood paneling and the textured outer surface of the rolls may include projections configured to deform the surface of the sheet of material to convey a texture associated with wood paneling.

In accordance with some specific implementations, the decorative plastic film may be comprised at least in part of one of polyvinyl chloride (PVC), polyethylene (PE), Poly(methyl methacrylate) (PMMA), acrylic, Polyvinylidene difluoride (PVDF) and polypropylene (PP). The decorative plastic film may be a single-layer plastic film or may be a multi-layer plastic film including two, three or more layers. In some specific practical implementations in which the decorative plastic film is a single-layer plastic film, the thickness of the decorative plastic film may be between about 0.5 mils and about 12 mils (where 1 mil-0.001 inches). In some specific practical implementations in which the decorative plastic film is a multi-layer plastic film, the thickness of the decorative plastic film may be between about 5 mils and about 30 mils. In some alternative specific practical implementations in which the decorative plastic film is a multi-layer plastic film, the multi-layer plastic film may have a thickness below 4 mils. In practical implementations, in which the decorative plastic film a multi-layer plastic film, the different layers of plastic film may be comprised of the same or of different materials and each layer may have a thickness different from that of the other layers in the plastic film.

In accordance with some specific implementations, the decorative plastic film may include an ink-based decorative element. The specific decorative elements and/or patterns conveyed by the ink-based decorative element may vary between implementations. For example, the ink-based decorative element may visually convey a material such as but without being limited to a carbon-finish, waves, camouflage and wood paneling. As another example, the ink-based decorative element may visually convey a graphical motif. As a non-limiting example, the graphical motif may be a flag (e.g. the American flag).

In some practical implementations of a first type, the ink-based decorative element may cover a portion of the decorative plastic film, wherein another portion of the decorative plastic film is characterized by an absence of ink-based decorative elements. More specifically, in some practical implementations, the portion of the decorative plastic film covered by the ink-based decorative element may comprise less than 85% of the surface of the decorative plastic film; in yet other implementations less than 50% of the surface of the decorative plastic film; in yet other implementations, less than 30% of the surface of the decorative plastic film; in yet other implementations, less than 15% of the surface of the decorative plastic film. An advantage of using ink-based decorative elements to cover a portion (but not all) the surface of the decorative plastic film may be that it allows colors and decorative elements that may already be present in the sheet of material to remain visible once the decorative plastic film is bonded to the sheet of material. For example when an extrusion based coloring process was used to generate the sheet of material (for example such as the one described in U.S. Pat. No. 7,204,944 or U.S. patent application Ser. No. 14/757,943), the color effects generated in the sheet of material may remain visible through the once the decorative plastic film.

In some practical implementations of a second type, the ink-based decorative element may cover substantially an entire extent of the decorative plastic film. More specifically, in some practical implementations, the portion of the decorative plastic film covered by the ink-based decorative element may comprise at least 85% of the surface of the decorative plastic film; in other implementations, the portion of the decorative plastic film covered by the ink-based decorative element is comprised of at least 90% of the surface of the decorative plastic film; in yet other implementations, the portion of the decorative plastic film covered by the ink-based decorative element is comprised of at least 95% of the surface of the decorative plastic film; in yet other implementations, the portion of the decorative plastic film covered by the ink-based decorative element is comprised of at least 99% of the surface of the decorative plastic film.

In some practical implementations, the roll of the decorative plastic film may have a dimension configured to substantially cover a width of the sheet of material released by the die. The width of the sheet may depend on specific uses that the sheet of material will be applied to. As a first specific example, in cases where the sheet of material may ultimately be used to make stand-up paddle boards or surf boards, the width of the sheet of material may be of at least 41 inches. As a second specific example, in cases where the sheet of material may ultimately be used to make kayaks et canoes, the decorative plastic film may have a width of at least 48 inches. As a third specific example, in cases where the sheet of material may ultimately be used to make boats, the decorative plastic film may have a width of at least 56 inches. As a fourth specific example, in cases where the sheet of material may ultimately be used to make luges, the decorative plastic film may have a width of at least 58 inches. As a fifth specific example, in cases where the sheet of material may ultimately be used to make pedal boats, the decorative plastic film may have a width of at least 70 inches.

In accordance with some specific implementations, the output assembly may include cutting elements configured for cutting the sheet of material into individual sheet portions. The output assembly may include a processor configured for controlling the timing and the positioning of the cutting element based upon one or more criteria. One of the criteria may be a desired length of the sheet of material. In accordance with some specific examples, the decorative plastic film may include a specific graphical pattern, and the output assembly may include optical sensors configured for gathering data conveying graphical information associated with the sheet of material to which the decorative plastic film has been applied. In such implementations, the processing module may be programmed for controlling the cutting elements at least in part based on the detected position of the specific graphical pattern to prevent cutting through the specific graphical pattern when cutting the sheet. More specifically, the processing module may be programmed for:
processing the data conveying graphical information associated with the sheet of material to which the decorative plastic film has been applied to detect a position of the specific graphical pattern;
controlling the cutting elements at least in part based on the position of the specific graphical pattern.

In accordance with some specific implementations, the extruder module is a first extruder module and the system may comprise one or more additional extruder modules for providing at one or more additional flows of viscous material. The feed block module includes a combining device for combining the flow of viscous material from the first extruder module with the one or more additional flows of viscous material provided by the one or more additional extruder module to form the released stream of viscous material, wherein the stream of viscous material released by the feed block module is a co-extruded stream having two or more layers.

In accordance with a second general aspect, a roll of decorative plastic film is provided for creating a decorative surface effect on an extruded plastic sheet. The roll of decorative plastic film is configured for lamination of the extruded sheet of plastic material and comprises:
a film layer having a first surface and a second surface;
an ink layer including an ink composition applied to the first surface of said film layer to convey a specific decorative effect.

In some specific practical implementations, the film layer of the decorative plastic film may be comprised at least in part of one of polyvinyl chloride (PVC), polyethylene (PE), Poly(methyl methacrylate) (PMMA), acrylic, Polyvinylidene difluoride (PVDF) and polypropylene (PP). In a very specific practical implementation, the film layer of the decorative plastic film may be comprised at least in part of polyethylene (PE) and/or of a material compatible to bond with polyethylene (PE).

In some specific practical implementations, the film layer of the decorative plastic film can be shaped into a three dimensional object using a thermoforming process and may have a thickness between about 0.5 mils and about 12 mils.

In some specific practical implementations, the first surface of the film layer may be treated for increasing adhesion of the ink composition to the film layer. As a first specific example, the first surface of the film layer may be treated with a mechanical process to increase adhesion of the ink composition to the first surface. Examples of mechanical processes that may be used include, without being limited to, using a blasting process (in French “Grenaillage”) to alter a profile of the first surface of the film layer and/or an abrasion process to roughen the first surface of the film layer. As a second specific example, the first surface of the film layer may be treated with a surface modification treatment to alter properties of the first surface of the film layer. Examples of surface modification treatments that may be used include, without being limited to, using a plasma treatment to impart changes in the properties of the first surface of the film layer. For example, a Corona treatment (or air plasma treatment) using a low temperature corona discharge plasma may be used to impart changes in the properties of the first surface of the film layer. As a third specific example, the first surface of the film layer may be treated with a chemical substance to alter properties of the first surface of the film layer. Examples of chemical treatment that may be used include, without being limited to, applying a chemical substance in the form of an oxidant applied to the first surface of the film layer and/or applying a chemical substance in the form of an adhesive primer (for example glue) to the first surface of the film layer at least in part to increase adhesion between the first surface of the film and the ink layer.

In some specific practical implementations, the second surface of the film layer may be treated with UV stabilizers to increase UV resistant properties associated with the film layer. In specific practical implementations, the UV stabilizers used to increase UV resistant properties associated with the film layer may include, without necessarily being limited to, at least one of an ultraviolet absorbers, an ultraviolet quencher and a hindered amine light stabilizer (HALS). It is to be appreciated that in alternative implementation, alternatively or in addition to treatment with UV stabilizers to increase UV resistant properties, other surface treatments may be applied to the second surface of the film layer to impart desirable properties including, without being limited to, anti-scratch treatments for example.

In some specific practical implementations, the ink layer may be comprised at least in part by a coloring agent, a carrier and additives. The proportions of each one of the coloring agent, a carrier and additives may vary between practical implementations. In some specific practical implementations, the coloring agent may form between 5% and 25% of the ink layer and is comprised of at least one of a pigment and colorants. Alone or in combination with the above coloring agent composition, the carrier may form about 70% of the ink layer and may be comprised of at least one of a polymer, a diluent and a solvent. Alone or in combination with the above coloring agent and carrier compositions, the additives may form between 5% and 25% of the ink layer. In a specific implementation, the additives may be used to increase adhesion of the ink to the first surface of the film layer and may form at least 10% of the ink layer.

In some specific practical implementations, the film layer may be a first film layer and the roll further may comprise a second film layer positioned opposite the first film layer and encapsulating the ink layer. The second film layer may adhere to the first film layers and the ink layer in any suitable fashion. For example, the second film layer may be laminated onto the first film layer.

In some specific practical implementations, the second film layer may be comprised at least in part of one of polyvinyl chloride (PVC), polyethylene (PE), Poly(methyl methacrylate) (PMMA), acrylic, Polyvinylidene difluoride (PVDF) and polypropylene (PP). It is to be appreciated that while the second film layer may be comprised of material and have a thickness similar to that of the first layer in some specific practical implementations, that need not be the case. In particular, the second layer may be comprised in some cases of a different material and/or have a different thickness than what is associated with the first layer. In a non-limiting implementation, the second layer may have a thickness between about 0.5 mils and about 12 mils. In a very specific practical implementation, the second film layer may be comprised at least in part of polyethylene (PE) which may facilitate adhesion of the decorative plastic film to the extruded plastic sheet formed of high density polyethylene (HDPE).

In some practical implementations, the roll of the decorative plastic film may have a dimension configured to cover substantially cover a width of the extruded plastic sheet with which it is to be laminated. The width of the sheet may depend on specific uses that the sheet of material will be applied to. In specific practical implementations, the width of the roll of decorative plastic film may be at least 41 inches; in other implementations, the width of the roll of decorative plastic film may be at least 48 inches; in other implementations, the width of the roll of decorative plastic film may be at least 56 inches; in other implementations, the width of the roll of decorative plastic film may be at least 58 inches; in other implementations, the width of the roll of decorative plastic film may be at least 70 inches.

In some specific implementations, the specific decorative effect conveyed by said ink-layer may include one of a carbon-finish, waves, camouflage and wood paneling. Alternatively, or in addition, the specific decorative effect conveyed by said ink-layer may include a graphical motif.

In accordance with a third general aspect, a roll of decorative plastic film is provided for creating a decorative surface effect on an extruded plastic sheet, the roll of decorative plastic film being configured for lamination of the extruded sheet of plastic material, the extruded sheet of plastic material being formed of high density polyethylene (HDPE). The roll of decorative plastic film comprises:
a first film layer having a first surface and a second surface, said film layer being comprised at least in part of one of polyvinyl chloride (PVC), polyethylene (PE), Poly(methyl methacrylate) (PMMA), acrylic, Polyvinylidene difluoride (PVDF) and polypropylene (PP);
an ink layer including an ink composition applied to the first surface of said first film layer to convey a specific decorative effect, wherein the first surface of the first film layer being treated for increasing adhesion of the ink composition to the film layer;
a second film layer positioned opposite the first film layer and encapsulating said ink layer, said second layer being bonded to said first film layer, wherein the second film layer is comprised at least in part of polyethylene (PE).

In accordance with a fourth general aspect, a process is provided for creating an extruded sheet having a decorative surface effect. The process comprises:
providing a viscous material;
extruding the viscous material using an extruder and releasing a stream of viscous material through a feedblock module;
forming the stream of viscous material into a sheet of material using a die positioned downstream from the feed block module;
smoothing the sheet of material after it is released by the die using a calander having a set of rolls positioned downstream from the die, wherein smoothing the sheet of material including feeding the sheet of material through the set of rolls of the calander in a specific sheet feed order;
cooling the sheet of material as it feed through the calendar to a specific temperature range;
applying a decorative plastic film to a surface of the sheet of material using a film application assembly including modules configured to cooperate with the calander, wherein applying the decorative plastic film to the surface of the sheet of material includes directing the decorative plastic film to position a surface of the decorative plastic film opposite the surface of the sheet of material;
directing the sheet of material to which the decorative plastic film has been applied towards an accumulation area.

In some specific implementations, the system is configured to operate on viscous material that may be a viscous plastic material. For example, the viscous plastic material may be formed of at least one of: polyethylene (PE), polypropylene (PP), acetal, acrylic, nylon (polyamides), polystyrene, polyvinyl chloride (PVC), acrylonitrile butadiene styrene (ABS) and polycarbonate. In a very specific practical implementation, the viscous plastic material may be formed of high density polyethylene (HDPE).

In some specific implementations, the process may include using adjacent rolls of the calendar to urge the surface of the decorative plastic film toward the opposed surface of the sheet of material to bond the decorative plastic film to the sheet of material. Alternatively, or in addition, the process may comprise using pressure rolls positioned downstream from the calander to urge the surface of the decorative plastic film toward the opposed surface of the sheet of material to bond the decorative plastic film to the sheet of material.

In some specific implementations, the process may also comprise heating the decorative plastic film to cause the decorative plastic film to be thermally bonded to the sheet of material. It is to be appreciated that the decorative plastic film may be heated directly by using a heat source directed to the decorative plastic film and/or indirectly by heating one or more of the pressure rolls used for urging the surface of the decorative plastic film toward the opposed surface of the sheet of material.

In some specific implementations, cooling the sheet of material as it feed through the calendar to a specific temperature range may include cooling the temperature of the sheet of material to no more than between about 250° F. and about 450° F. to allow the decorative plastic film to thermally bond with the sheet of material. Once the decorative plastic film has been applied to the sheet of material, the process may further comprise cooling the temperature of the sheet of material to which the decorative plastic film has been applied to below about 200° F., and preferably in some cases to below 115° F.

In some specific implementations, the film application assembly further comprises modules for applying one or more specific treatments to the decorative plastic film prior to position the decorative plastic film opposite the surface of the sheet of material. The type of treatment may vary between specific embodiments and may be configured according to the type of effect desired. For example, the one or more specific treatments which the modules of the film assembly may be configured to apply may include a surface modification treatment to alter properties of the surface of decorative plastic film to be positioned opposite the surface of the sheet of material (for example to increase adhesion of the film to the surface of the sheet of material, and/or to increase flexibility of the decorative film). In non-limiting example, the modules of the film assembly may include a plasma device for releasing a low-temperature corona discharge plasma to impart changes in the properties of the surface of decorative plastic film to be positioned opposite the surface of the sheet of material. Alternatively, or in addition, the modules of the film assembly may include a chemical applicator module for applying a chemical substance, such as without being limited to an oxidant and an adhesive primer (for example glue), to the surface of decorative plastic film to be positioned opposite the surface of the sheet of material. In addition to, or alternatively, the modules of the film assembly may be configured to heat the decorative plastic film to increase a level of adhesion between the decorative plastic film and the sheet of material.

In some specific implementations, the process may comprise imparting a three-dimensional texture on the surface of the sheet of material to which the decorative plastic film is applied by using one or more rolls of the calendar having a textured outer surface including projections for creating the three-dimensional texture.

In some specific practical implementations, the film layer of the decorative plastic film may be comprised at least in part of one of polyvinyl chloride (PVC), polyethylene (PE), Poly(methyl methacrylate) (PMMA), acrylic, Polyvinylidene difluoride (PVDF) and polypropylene (PP). In a very specific practical implementation, the film layer of the decorative plastic film may be comprised at least in part of polyethylene (PE) and/or of a material compatible to bond with polyethylene (PE).

In some specific practical implementations, the process may further comprise cutting the sheet of material into individual sheet portions. In some specific practical implementations, in which the decorative plastic film may include a specific graphical pattern, the process may comprise:
gathering image data conveying graphical information associated with the sheet of material to which the decorative plastic film has been applied;
processing the data conveying graphical information associated with the sheet of material to which the decorative plastic film has been applied to detect a position of the specific graphical pattern; and
controlling cutting elements at least in part based on the detected position of the specific graphical pattern when cutting the sheet of material into individual sheet portions to avoid cutting through the specific graphical pattern.

In some specific practical implementations, the process may further comprise providing one or more additional flow of viscous material and combining the flow of viscous material with the one or more additional flows of viscous material to form the released stream of viscous material, wherein the stream of viscous material released by the feed block module is a co-extruded stream having two or more layers.

In accordance with a fifth general aspect, a process for manufacturing a plastic article having a decorated surface is provided. The process comprises manufacturing sheets of extruded plastic material having a decorative surface effect using a process of the type described above and molding one or more of the manufactured sheets of extruded material using thermoforming to shape the one or more manufactured sheets into the plastic article.

In accordance with a sixth general aspect, a process for manufacturing a kayak having a decorated surface is provided. The process comprises molding two or more manufactured sheets of extruded material using thermoforming to shape the two of more manufactured sheets into a kayak shape, at least one of the two or more of the manufactured sheets having decorative surface effects created using a process of the type described above.

In accordance with another aspect, a sheet of extruded material having decorative surface effects is provided. The sheet of extruded material comprises a first layer comprised of extruded plastic material and a second layer thermally bonded to a surface of the first layer, wherein the second layer is comprised of decorative plastic film from a roll of decorative plastic film of the type described above.

In accordance with another aspect, a plastic article is provided manufactured at least in part using one or more sheets of extruded material having decorative effects of the type described above.

In accordance with another aspect, a process for manufacturing a plastic article comprising decorative surface effects is presented. The process comprises molding two or more of the manufactured sheets of extruded material using thermoforming to shape the two of more manufactured sheets into a kayak shape, at least one of the two or more of the manufactured sheets having decorative surface effects created using a process of the type described above.

In specific practical implementations, another one of the two or more of the manufactured sheets may have a uniform color or, alternatively, may also have decorative surface effects created using a process of the type described above.

In specific practical implementations, the process and resulting manufactured extruded plastic sheets may be suitable for use during manufacturing of many different types of plastic products including, but without being limited to, kayaks, sleds, stand-up paddle boards and other outdoor plastic articles (e.g. yard equipment such as cabanas/storage containers and yard furniture such as chairs) amongst many others.

All features of embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

A detailed description of specific embodiments of the present invention is provided herein below with reference to the accompanying drawings in which:

FIGS. 1A to 1C show a system for manufacturing extruded plastic sheets having decorative surface effects according to a non-limiting example of implementation of the present invention;

FIGS. 2A to 2C show a system for manufacturing extruded plastic sheets having decorative surface effects according to an alternative non-limiting example of implementation of the present invention;

FIG. 3 is a sketch of a non-limiting example of a film application assembly and a calendar for use in a system of the type shown in any one of FIGS. 1A, 1B, 1C, 2A, 2B and 2C;

FIG. 4 graphically illustrates effect of a blasting process (in French “Grenaillage”) that may be applied to a surface of a film layer of a decorative plastic film to alter a profile of the surface and increase adhesion of an ink composition in accordance with a specific embodiment of the present invention;

FIG. 5 is a flowchart illustrating a process for creating decorative surface effects in extruded plastic material according to an example of implementation of the present invention; and

FIGS. 6A and 6B show various decorative surface effects applied to an extruded plastic sheet according to examples of implementation of the present invention and variants thereof; and

FIG. 7 shows kayaks manufactured using plastic sheets of extruded material created using a process embodying some aspects of the invention;

FIGS. 8A and 8B show top plan and side views respectively of a stand-up paddle board (SUP) manufactured using plastic sheets of extruded material created using a process embodying aspects of the invention.

In the drawings, embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The present document presents specific examples of a system, a process, a decorative plastic film and a sheet of extruded material with decorative surface effects in accordance with some embodiments of the invention.

In the following examples of implementation, the present invention will be described for use in creating decorative surface effects in connection with extruded plastic sheets. However, it is to be appreciated that the invention may not necessarily be limited to a particular type of material. Rather, the concepts described in the present document may be applied to different types and grades of extruded materials.

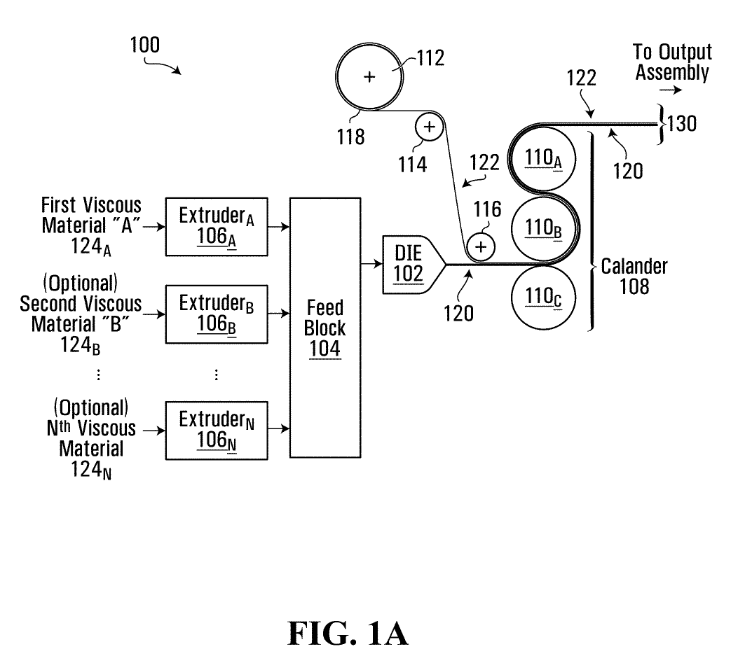

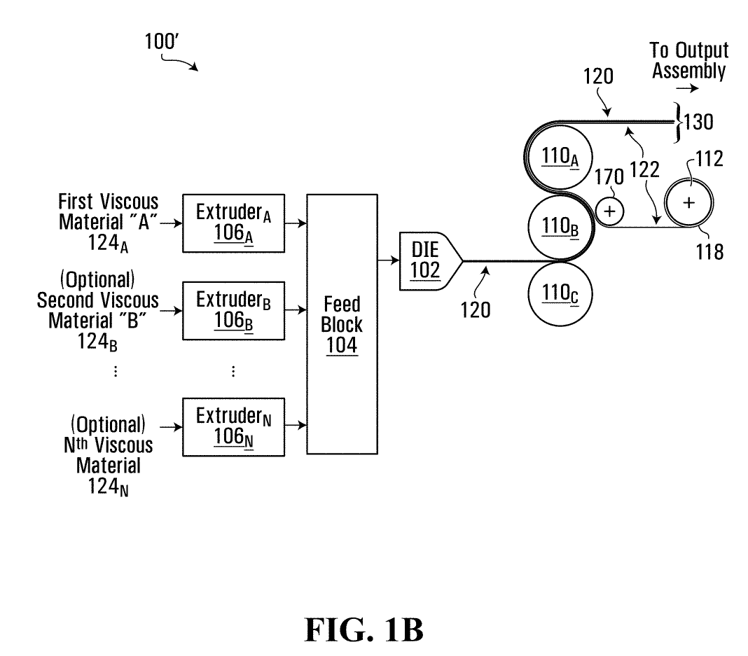

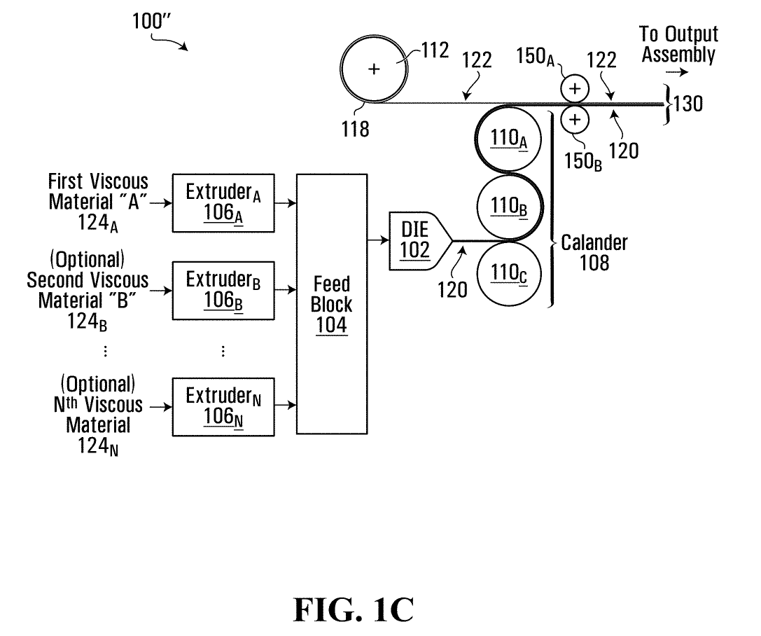

FIG. 1A depicts a system 100 for manufacturing extruded plastic sheets having a decorative surface effect, according to a non-limiting example of implementation of the present invention. The system 100 shown is formed of several components, including a primary extruder 106_{A} for providing a first viscous material (“A”), a feed block 104, a die 102, a calander 108 having a set of rolls 110_{A . . . C} and a film application assembly. These aforementioned components cooperate in order to produce a laminated sheet of material 130, which is then dispatched to an output assembly (not shown). Optionally, the system may also include one or more additional extruders 106_{B}, . . . , 106_{N}, where the number of secondary extruders in the system 100 may vary. For example, there may be no secondary extruders, one (1) secondary extruder, two (2) secondary extruders, three (3) secondary extruders etc. . . . in various embodiments.

Extruders 106_{A . . . C} are configured for mixing and heat granules of viscous material 124_{A} (“A”) 124_{B} (“B”) . . . 124_{N} (“N”). The granules are heated to a predetermined temperature, sufficient to cause melting of the granules for producing a homogeneous, viscous plastic mixture. Examples of the different types of (thermo)plastic materials that can be extruded include: polyethylene (PE), polypropylene (PP), acetal, acrylic, nylon (polyamides), polystyrene, polyvinyl chloride (PVC), acrylonitrile butadiene styrene (ABS) and polycarbonate, among other possibilities. In a specific practical application, the viscous plastic material may be formed of high density polyethylene (HDPE).

The extruders 106_{A . . . N} are configured to melt and mix the plastic granules such that the mixture which is released from extruder 106 is melted and generally homogeneous upon its exit. Note that, with regard to the plastic mixtures released by the extruders 106_{A . . . N}, the term “melted” implies that the mixtures are characterized by viscous or semi-fluid flows. The plastic mixtures released are also referred to herein as flows of viscous material.

The structure and functionality of extruders are well known to those skilled in the art, and will not be described in further detail. In some variants of implementation (not shown in the Figures), the extruders 106_{A . . .} may be configured in different manners to create color effects in the flow of viscous materials in the manner described in U.S. patent application Ser. No. 14/757,943 filed Dec. 23, 2016 and in U.S. Pat. No. 7,204,944 issued on Apr. 17, 2003.

The contents of the aforementioned patent application are incorporated herein by reference. In such variants, the extruders may comprise flow rate controllers, static mixers and/or other components in order to achieve a desired color effect. The plastic mixtures (flows) released by the extruders 106_{A . . . N} are then provided to the feed block 104.

The feed block 104 is configured for combining the flows of viscous plastic output by the different extruders 106_{A . . . N} into a single stream of viscous plastic material. The manner in which the flows may be combined into a stream of viscous plastic material may vary between practical implementations. In the example depicted, the feed block 104 has a set of inputs corresponding to the number of secondary extruders 120₁, . . . , 120_{N} in the system 100. In some implementations, the feed block 104 may include a programming section to shape and position the flows according to a predetermined pattern, whereby the flows undergo a programming of sorts in order to produce a desired pattern for the stream of combined viscous material. It is to be appreciated that different sizes, shapes and layouts for channels of the programming section may also be used, in order to produce different patterns for the stream of combined viscous material. Finally, the feed block 104 includes a transition section operative to fuse together the separate flows for generating the patterned stream of combined viscous material. As the distinct flows exit the feed block 104, the flows of the viscous plastics, fuse together into a single, combined stream of viscous plastic.

The use of feed blocks in extrusion processes is well known in the art and, as such, additional details pertaining to the feed block structure and functionality will not be described in further detail herein.

The die 102 is positioned downstream from the feed block 104 to receive the stream of combined viscous material and is configured to shape the stream of combined viscous material into its final product form. In the system shown in FIG. 1, the die 102 is configured to produce sheets of extruded plastic material 120 from the stream of combined viscous material. The structure and functionality of dies such as die 102 are well known to those skilled in the art, and as such will not be described in further detail herein.

The calander 108 is positioned downstream from the die 102 and includes a set of rolls 110_{A . . . C} for smoothing the sheet of material 120 after it is released by the die 102. The rolls are positioned so that at least some of the rolls are adjacent to other rolls in the calendar. While the example depicted shows a calander 108 having three rolls 110_{A . . . C}, the person skilled in the art will appreciate that alternate implementations may include additional or fewer rolls.

In use the sheet of material 120 released by the die 102 may be feed through the set of rolls 110_{A . . . C} of the calander 108 in a specific sheet feed order. The specific sheet feed order may generally characterized by a sequence of pairs of adjacent rolls of the calander 108 between which the sheet of material 120 is fed. For example, with reference to FIG. 1A, the specific sheet feed order may be characterized by {110_{C}-110_{B}; 110_{B}-110_{A}, 110_{A}-END}.

The film application assembly includes modules configured to cooperate with the calander 108 for applying a decorative plastic film 122 to a surface of the sheet of material 120. In the specific implementation shown in FIG. 1A, the film application assembly includes a support structure 112 for holding a roll of the decorative plastic film 118 and a film feeding mechanism configured to direct the decorative plastic film 122 to position a surface of the decorative plastic film opposite the surface of the sheet of material 120.

In some specific implementations of a first type, the film feeding mechanism includes positioning members for directing the decorative plastic film between adjacent rolls in the set of rolls of the calander 108 wherein adjacent rolls of the calendar 108 are configured to urge the surface of the decorative plastic film 122 toward the opposed surface of the sheet of material 120 to bond the decorative plastic film 122 to the sheet of material 120. In some specific practical implementations, the positioning members of the film feeding mechanism may include positioning rolls, such as banana rolls. The positioning members may be configured to cooperate with the calander 108 to direct the decorative plastic film 120 through the rolls of the calander in a specific film feed order.

The configuration of the film application assembly, its positioning relative to the calander 108 and the manner in which it cooperates with the calander 108 to apply the decorative plastic film 122 to a surface of the sheet of material 120 to obtain a laminated sheet of material 130 may vary between implementations. In addition, in some practical implementations some elements of the film application assembly may be positioned upstream, downstream or both upstream and downstream from the rolls of the calendar 108. Examples of some possible configurations may be best understood with reference to FIGS. 1A, 1B and 1C of the figures.

More specifically, FIG. 1A of the drawings shows a first configuration of the film application assembly in which elements 112 118 114 116 of the film application assembly are positioned upstream from the rolls of the calander 108. In this embodiment, the positioning members include banana rolls 114 and 116 are configured to cooperate with the calander 108 to direct the decorative plastic film 120 through the rolls of the calander in a specific film feed order that is the same as the specific sheet feed order. In particular, in the embodiment shown in FIG. 1A, the specific sheet feed order and the specific film feed order are characterized by a same sequence of pairs of adjacent rolls of the calander between which the sheet of material and the plastic film are fed, namely {110_{C}-110_{B}; 110_{B}-110_{A}, 110_{A}-END}.

FIG. 1B shows another system 100′ for manufacturing extruded plastic sheets having a decorative surface effect and is an alternative to the system 100 depicted in FIG. 1A. Similar items have been designated with same reference numerals. In system 100′, a second configuration of the film application assembly in which elements 112 170 of the film application assembly are positioned downstream from the rolls of the calander 108. In this embodiment, the positioning members include banana roll 170 which is configured to cooperate with the calander 108 to direct the decorative plastic film 120 through the rolls of the calander in a specific film feed order that is the different from the specific sheet feed order. In the embodiment shown in FIG. 1B, the specific sheet feed order and the specific film feed order are characterized by different sequences of pairs of adjacent rolls of the calander between which the sheet of material and the plastic film are fed. In particular, pair of rolls {110_{C}-110_{B}} is omitted from the specific sequence of pairs of adjacent rolls between which the plastic film is fed.

FIG. 1C shows yet another system 100″ for manufacturing extruded plastic sheets having a decorative surface effect and is another alternative to the system 100 depicted in FIG. 1A. Similar items have been designated with same reference numerals. In system 100″ includes a third configuration of the film application assembly in which elements 112 and 118 are positioned upstream from the rolls of the calander 108 and elements 150_{A} and 150_{B} are positioned downstream from the rolls of the calander 108. In this embodiment, elements 150_{A} and 150_{B} are «nip rolls» that act as positioning members and pressure rolls configured to urge the surface of the decorative plastic film 122 toward the opposed surface of the sheet of material 120 to bond the decorative plastic film 122 to the sheet of material 120. An advantage of a configuration of the type depicted in FIG. 1C is that the level of force/pressure for smoothing the sheet of material 120 after it is released by the die 102 and applied by the calander rolls 110_{A . . . C} can be set independently from the level of force/pressure for laminating the decorative plastic film 122 to the sheet of material 120 and it may therefore be possible to achieve improved results by independently tweaking the pressure settings for each. For example, in some specific embodiments elements 150_{A} and 150_{B} may be configured for applying a force/pressure for laminating the decorative plastic film 122 to the sheet of material 120 in a range between 10 psi and 60 psi. In some non-limiting implementations, the 150_{A} and 150_{B} may be configured for applying a force/pressure of about 40 psi. Another advantage of the configuration described here is that the position of the contact between the decorative plastic film 122 and the sheet of material 120 can be chosen as a function of a desired application temperature of the decorative film 122 in order to avoid damaging it. In particular, the decorative plastic film 122 tends to have a lower high-temperature tolerance than the sheet of material 120. As such, the later in the process the decorative plastic film 122 is placed onto the sheet of material 120, the colder the sheet of material 120. Optionally, the temperature of element 150_{A} may be controlled to within a certain target range to heat the decorative film 122. In some practical implementations, the element 150_{A} may be heated to a target temperature between 250° F. and 500° F.; preferably between 300° F. and 400° F. In a non-limiting implementation, the element 150_{A} may be heated to a temperature of about 350° F. The heating of element 150_{A} may be achieved using any suitable mechanism, which would typically include thermal elements combined with temperature sensing and control elements. For example, element 150_{A} may be heated using liquid heating (e.g. by circulating water and/or another substance having a temperature within a specific temperature range in piping in are in an area adjacent to element 150_{A}). In this embodiment, the specific film feed order is different from the specific sheet feed order. In the embodiment shown in FIG. 1C, the specific sheet feed order and the specific film feed order are characterized by different sequences of pairs of adjacent rolls of the calander between which the sheet of material and the plastic film are fed. In particular, the specific sheet feed order is {110_{C}-110_{B}; 110_{B}-110_{A}, 110_{A}-END} which the specific film feed order through the calander is {110_{A}-END}.

It is to be appreciated that while different configurations of systems for manufacturing extruded plastic sheets having a decorative surface effect have been presented in FIGS. 1A, 1B and 1C many other suitable configurations many be contemplated and will become apparent to the person skilled in the art in view of the present description.

It is to be appreciated that in the configurations of systems presented in FIGS. 1A, 1B and 1C, the modules of the film application assembly configured to cooperate with the calander 108 for applying the decorative plastic film 122 to cause the decorative plastic film 122 to be bonded to the sheet of material 120.

The nature of the bond created between the decorative plastic film 122 and the sheet of material 120 may vary. For example, the decorative plastic film 122 may be thermally bonded to the sheet of material 120; and/or the decorative plastic film 122 may be chemically bonded to the sheet of material 120. In specific practical implementations, the film application assembly may include modules for heating the decorative plastic film to cause the decorative plastic film to be thermally bonded to the sheet of material and/or may comprise modules for applying a chemical (e.g. an adhesive) between the decorative plastic film 122 to be bonded to the sheet of material 120 so that the decorative plastic film 122 is chemically bonded to the sheet of material 120.

In some configurations, the film application assembly may further comprise modules for applying one or more specific treatments to the decorative plastic film prior to positioning the decorative plastic film opposite the surface of the sheet of material.

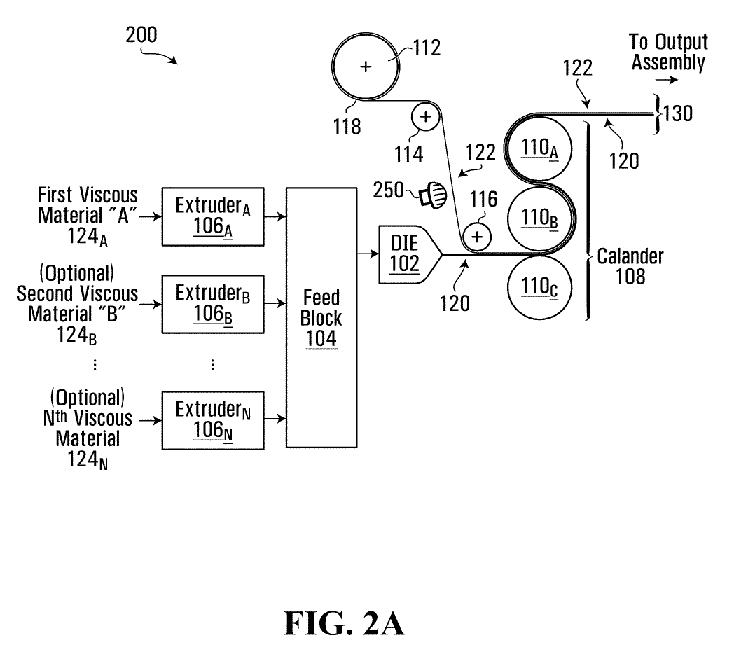

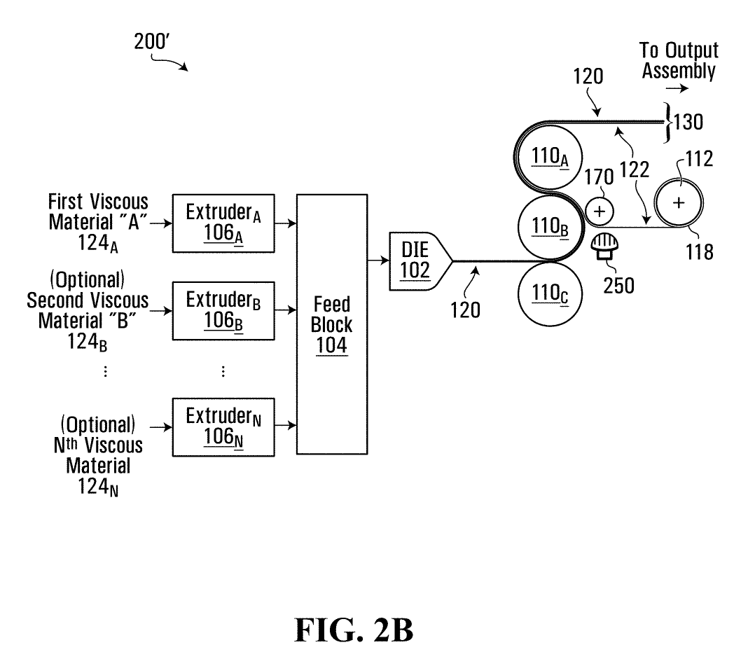

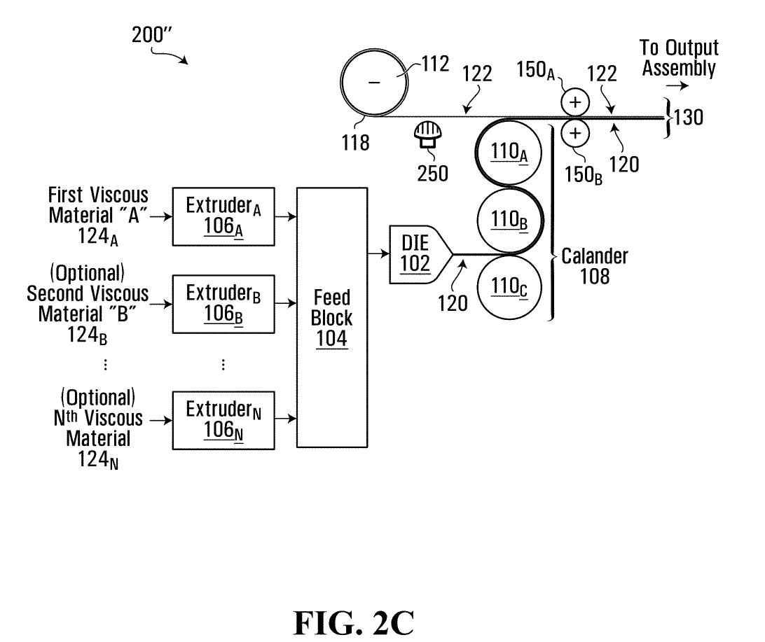

FIGS. 2A, 2B and 2C show configurations of systems similar to the configurations of FIGS. 1A, 1B and 1C respectively with an integrated film-treatment module 250. In the examples shown, the film-treatment module 250 is positioned up-stream from the location where the decorative film 122 is applied to the sheet of material 120 however it is possible for the system to also include film-treatment modules that may be located down-stream from the location where the decorative film 122 is applied.

In some implementations, the film-treatment module 250 may be configured to apply a surface modification treatment to alter properties of the surface of decorative plastic film 122 that is to be positioned opposite the surface of the sheet of material 120. For example, the film-treatment module 250 may include a plasma device for releasing a low temperature corona discharge plasma to impart changes in the properties of the surface of decorative plastic film 122. In another example, the film-treatment module 250 may include a chemical applicator module for applying a chemical substance to the surface of decorative plastic film 122. Various chemical substances may be contemplated depending on the desired effect. Specific examples of chemical substances may include, without being limited to, an oxidant and an adhesive primer (for example glue). In yet another example, the film-treatment module 250 may include a heating device configured to heat the decorative plastic film to increase a level of adhesion between the decorative plastic film and the sheet of material.

It is to be appreciated that while in FIGS. 2A, 2B and 2C as well as in the description above a film-treatment module 250 configured to apply a surface modification treatment to alter properties of the surface of decorative plastic film 122 was described, in alternate embodiments the system may instead (or in addition) include one or more sheet-treatment modules (not shown in the figures) for applying a surface modification treatment to the sheet of material 120 released by the die. These one or more sheet-treatment modules may be positioned up-stream from the location where the decorative film 122 is applied to the sheet of material 120 however it is possible for the system to also include sheet-treatment modules that may be located down-stream from the location where the decorative film 122 is applied.

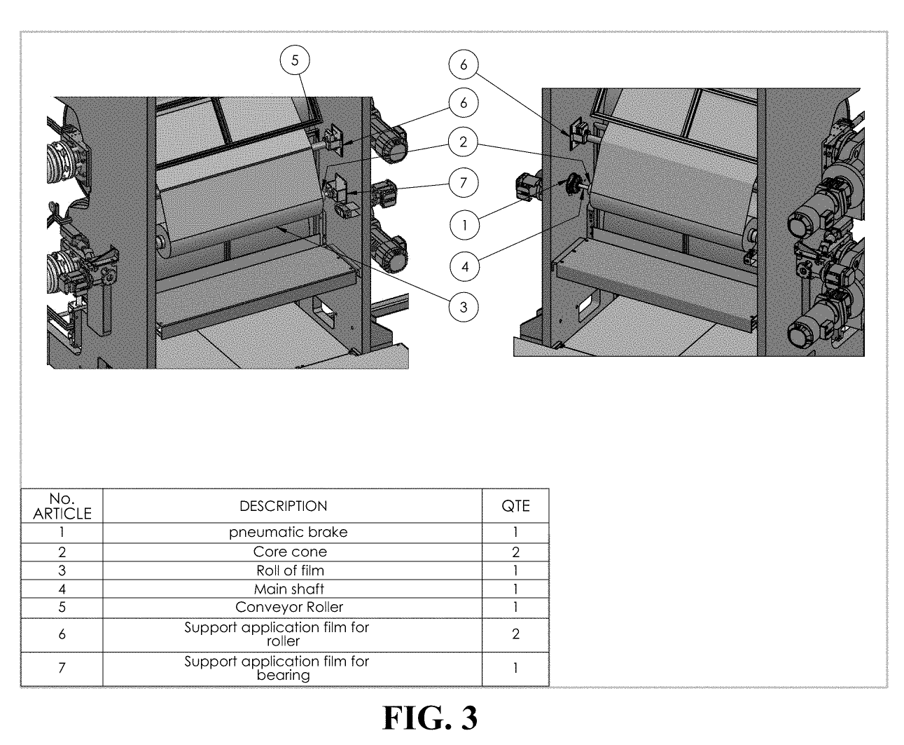

FIG. 3 is a sketch of a non-limiting example of a film application assembly and a calendar for use in a system of the type shown in any one of FIGS. 1A, 1B, 1C, 2A, 2B and 2C.

In some specific practical implementations, at least some of rolls 110_{A . . . C} in the calender 108 are configured for cooling the temperature of the sheet of material 120 so that it may acquire a more rigid texture. Preferably, the sheet of material 120 is cooled to no less than between about 250° F. and about 450° F. to allow the decorative plastic film to thermally with the sheet of material. The specific manner in which the rolls of the calander may cool the sheet of material may vary between implementations and may include, without being limited to, liquid cooling (e.g. by circulating water and/or a coolant having temperature within a specific temperature range in piping in are in an area adjacent to the rolls) and air cooling (ventilation).

Optionally, at least some of rolls 110_{A . . . C} in the calender 108 may have a textured outer surface configured for imparting a three-dimensional texture on the surface of the sheet of material to which the decorative plastic film is applied. In this regard, the textured outer surface of at least some of rolls 110_{A . . . C} may include projections for creating the three-dimensional texture on the surface of the sheet of material. In specific practical implementations, the decorative plastic film 122 may include one or more graphical elements and the textured outer surface of the rolls may be configured to complement the one or more graphical elements of the decorative plastic film.

For example, the one or more graphical elements of the decorative plastic film 122 may convey images of wood paneling and the textured outer surface of the rolls may include projections configured to deform the surface of the sheet of material to convey a texture associated with wood paneling.

The accumulation area (not shown in the Figures) may include an output assembly having cutting elements (e.g. blades) configured for cutting the sheet of material into individual sheet portions. The output assembly may include a processor configured for controlling the timing and the positioning of the cutting element based upon one or more criteria. One of the criteria may be a desired length of the sheet of material. In accordance with some specific examples, the decorative plastic film may include a specific graphical pattern, and the output assembly may include optical sensors configured for gathering data conveying graphical information associated with the sheet of material to which the decorative plastic film has been applied. In such implementations, the processing module may be programmed for controlling the cutting elements at least in part based on the detected position of the specific graphical pattern to prevent cutting through the specific graphical pattern when cutting the sheet. More specifically, the processing module may be programmed for:
receiving image data obtained by an optical sensor, wherein the data conveys graphical information associated with the sheet of material to which the decorative plastic film has been applied;
processing the data to derive information conveying a position of the specific graphical pattern;
controlling the cutting elements at least in part based on the derived information conveying the position of the specific graphical pattern.

It is to be appreciated that deriving the information conveying a position of the specific graphical pattern based on image data may be performed using any suitable image processing techniques. Such techniques are known in the art of image processing and as such will not be described in further detail here.

### Roll of Decorative Plastic Film 118

As indicated above, the systems shown in FIGS. 1A, 1B, 1C, 2A, 2B and 2C make use of a roll of decorative plastic film 118 to create a decorative surface effect on an extruded plastic sheet. The configuration of the roll of decorative plastic film 118 may vary between implementations. In specific implementation, the decorative plastic film may include a first film layer having a first surface and a second surface and an ink layer including an ink composition applied to the first surface of the first film layer to convey a specific decorative effect. The decorative plastic film may also include a second film layer positioned opposite the first film layer and encapsulating the ink layer and the second film layer may be bonded to the first film layer.

The roll of decorative plastic film 118 with desired characteristics may be purchased from commercial vendors and/or manufactured according to certain desired specifications/requirements.

The first (and second) film layer(s) of the decorative plastic film may be comprised at least in part of one of polyvinyl chloride (PVC), polyethylene (PE), Poly(methyl methacrylate) (PMMA), acrylic, Polyvinylidene difluoride (PVDF) and polypropylene (PP).

It is to be appreciated that, with respect to lamination, since the resulting material 130 is a composite material that is made up of multiple layers of different materials (namely the extruded sheet of material 120 and the decorative film 122), to create the final product these layers need to adhere to one another and be assembled into a final unit. Such assembly is typically accomplished by heating, compressing, welding or gluing the layers together. When the materials in the various layers are substantially different, the assembly processes may be challenging as incompatible materials may be difficult to bond together and therefore will have a tendency to separate. For that reason it has been found that when the sheet of material 120 is comprised of high density polyethylene (HDPE), it may be advantageous for parts of the decorative plastic film that will be in contact with the sheet of material 120 (either the first film layer or the second film layer) to be comprised at least in part of polyethylene (PE).

The decorative plastic film is preferably sufficiently malleable under certain temperature conditions to be shaped into a three dimensional object using a thermoforming process. In practical implementations in which there is a single film layer (the first film layer), the film layer may typically have a thickness between about 0.5 mils and about 12 mils. When a second film layer is also provided, the second film layer may also have a thickness between about 0.5 mils and about 12 mils.

In some implementations, the first surface of the first film layer may be treated in order to increase adhesion of the ink composition to the first film layer.

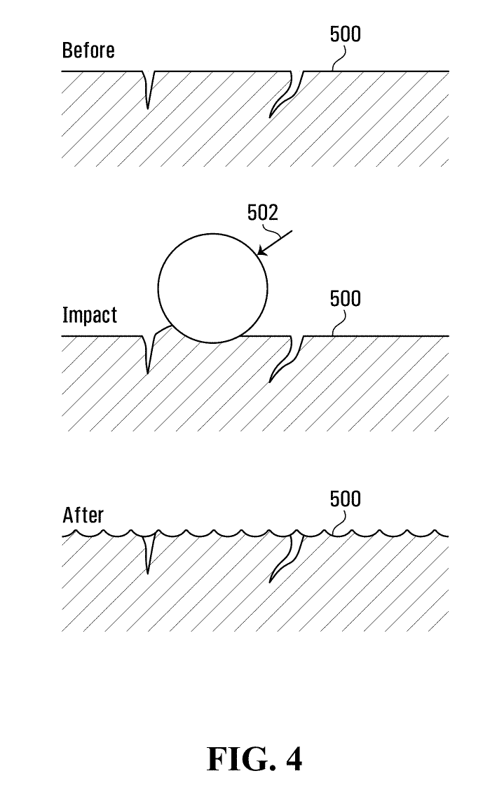

As a first example, the first surface of the first film layer may be treated with a mechanical process to increase adhesion of the ink composition to the first surface. Examples of mechanical processes may include using a blasting process (in French “Grenaillage”) to alter a profile of the first surface of the first film layer and an abrasion process to roughen the first surface of the film layer. FIG. 4 graphically illustrates effect of a blasting process (in French “Grenaillage”) that may be applied to a surface 500 of a film layer of a decorative plastic film to alter a profile of the surface and increase adhesion of an ink composition in accordance with a specific embodiment of the present invention. The process may typically include projecting micro-particles 502 on the surface 500 of the film using a blasting machine to modify its surface structure.

In some implementations, the second surface of the first film layer (the one opposed to the surface on which the inlayer is applied) may be treated with UV stabilizers to increase UV resistant properties associated with the film layer. Examples of UV stabilizers that may be used to increase UV resistant properties associated with the film layer include, without being limited to, an ultraviolet absorbers, an ultraviolet quencher and a hindered amine light stabilizer (HALS).

In some specific practical implementations, the ink layer may be comprised at least in part by a coloring agent, a carrier and additives. The proportions of each one of the coloring agent, a carrier and additives may vary between practical implementations. In some specific practical implementations, the coloring agent may form between 5% and 25% of the ink layer and is comprised of at least one of a pigment and colorants. Alone or in combination with the above coloring agent composition, the carrier may form about 70% of the ink layer and may be comprised of at least one of a polymer, a diluent and a solvent. Alone or in combination with the above coloring agent and carrier compositions, the additives may form between 5% and 25% of the ink layer. In a specific implementation, the additives may be used to increase adhesion of the ink to the first surface of the first film layer.

In some practical implementations, the roll of the decorative plastic film may have a dimension configured to substantially cover a width of the extruded plastic sheet with which it is to be laminated. The width of the sheet may depend on specific uses that the sheet of material will be applied to. In specific practical implementations, the width of the roll of decorative plastic film may be at least 41 inches; in other implementations, the width of the roll of decorative plastic film may be at least 48 inches; in other implementations, the width of the roll of decorative plastic film may be at least 56 inches; in other implementations, the width of the roll of decorative plastic film may be at least 58 inches; in other implementations, the width of the roll of decorative plastic film may be at least 70 inches.

In some specific implementations, the specific decorative effect conveyed by said ink-layer may include one of a carbon-finish, waves, camouflage and wood paneling. Alternatively, or in addition, the specific decorative effect conveyed by said ink-layer may include a graphical motif (e.g. a flag).

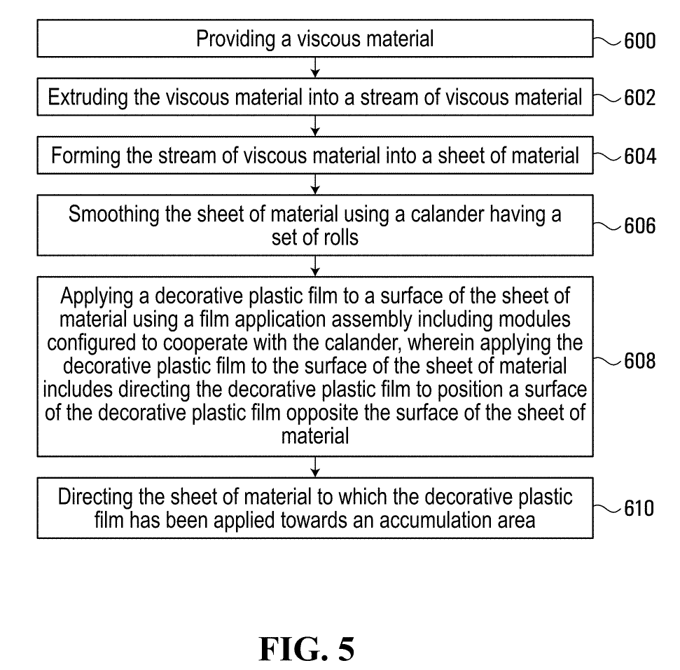

A specific example of a process for creating decorative surface effects in extruded plastic material according to an example of implementation with now be described with reference to FIG. 5 of the drawings and with reference to components depicted in FIGS. 1A, 1B, 1C, 2A, 2B and 2C.

At step 600, a viscous material 124_{A . . . N} is provided. The viscous material 124_{A . . . N} may be a viscous plastic material and may be formed of material including, without being limited to polyethylene (PE), polypropylene (PP), acetal, acrylic, nylon (polyamides), polystyrene, polyvinyl chloride (PVC), acrylonitrile butadiene styrene (ABS) and polycarbonate. In a preferred practical implementation, the viscous plastic material is formed of high density polyethylene (HDPE).

At step 602, the viscous material 124_{A . . . N} is extruded using an extruder 106_{A . . . N} and a stream of extruded viscous material is released through a feedblock module 104.

At step 604, the stream of viscous material is formed into a sheet of material 120 using a die 102 positioned downstream from the feed block module 104.

At step 606, the sheet of material 120 is smoothed after it is released by the die using a calander 108 having a set of rolls 110_{A . . . C} positioned downstream from the die 102. Smoothing the sheet of material 120 includes feeding the sheet of material through the set of rolls 110_{A . . . C} of the calander 108 in a specific sheet feed order.

The sheet of material 120 may also be cooled to a specific temperature range as it fed through the calendar 108 which may include, without being limited to, liquid cooling (e.g. by circulating water and/or a coolant having temperature within a specific temperature range in piping in are in an area adjacent to the rolls) and air cooling (ventilation).

Optionally, a three-dimensional texture may be imparted to the surface of the sheet of material to which the decorative plastic film is applied by using one or more rolls of the calendar.

At step 608, the decorative plastic film 122 is applied to a surface of the sheet of material 120 using a film application assembly including modules configured to cooperate with the calander 108. Applying the decorative plastic film 122 to the surface of the sheet of material 120 includes directing the decorative plastic film 122 to position a surface of the decorative plastic film 122 opposite the surface of the sheet of material 120. The decorative plastic film may be comprised at least in part of one of polyvinyl chloride (PVC), polyethylene (PE), Poly(methyl methacrylate) (PMMA), acrylic, Polyvinylidene difluoride (PVDF) and polypropylene (PP).

As depicted in the system configuration shown in FIGS. 1A, 1B, 2A and 2B, adjacent rolls of the calendar 108 may be used to urge the surface of the decorative plastic film 122 toward the opposed surface of the sheet of material 120 to bond the decorative plastic film to the sheet of material. Alternatively (or in addition), as depicted in the system configuration shown in FIGS. 1C and 2C pressure rolls positioned downstream from the calander may be used to urge the surface of the decorative plastic film toward the opposed surface of the sheet of material to bond the decorative plastic film to the sheet of material.

The decorative plastic film may be heated, for example using film-treatment module 250 shown in FIGS. 2A-C, to cause the decorative plastic film to be thermally bonded to the sheet of material. Alternatively, or in addition, one or more of the pressure rolls (such as for example nip roll 150A shown in FIGS. 1C and 2C) may be heated so that the temperature of its external surface lies within a certain target temperature range in order to heat the decorative film 122 as it passes under the pressure roll in order to cause the decorative plastic film to be thermally bonded to the sheet of material.

At step 610, the resulting product 130 comprised of the sheet of material 120 to which the decorative plastic film 122 has been applied is directed towards an accumulation area.

Optionally, in the accumulation area, the sheet of material may be cut into individual sheet portions. Optionally still, the decorative plastic film may include a specific graphical pattern and the process may include:
using an optical sensor, gathering image data conveying graphical information associated with the sheet of material to which the decorative plastic film has been applied;
processing the data to derive information conveying a position of the specific graphical pattern;
controlling cutting elements at least in part based on the derived information conveying the position of the specific graphical pattern such as to cut the sheet of material into individual sheet portions while avoiding cutting through the specific graphical pattern.

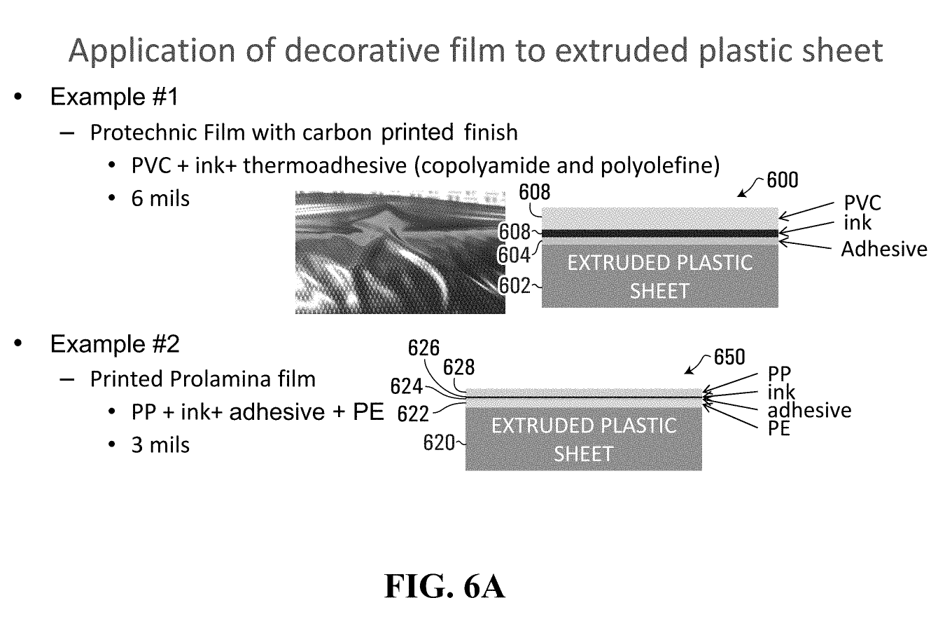

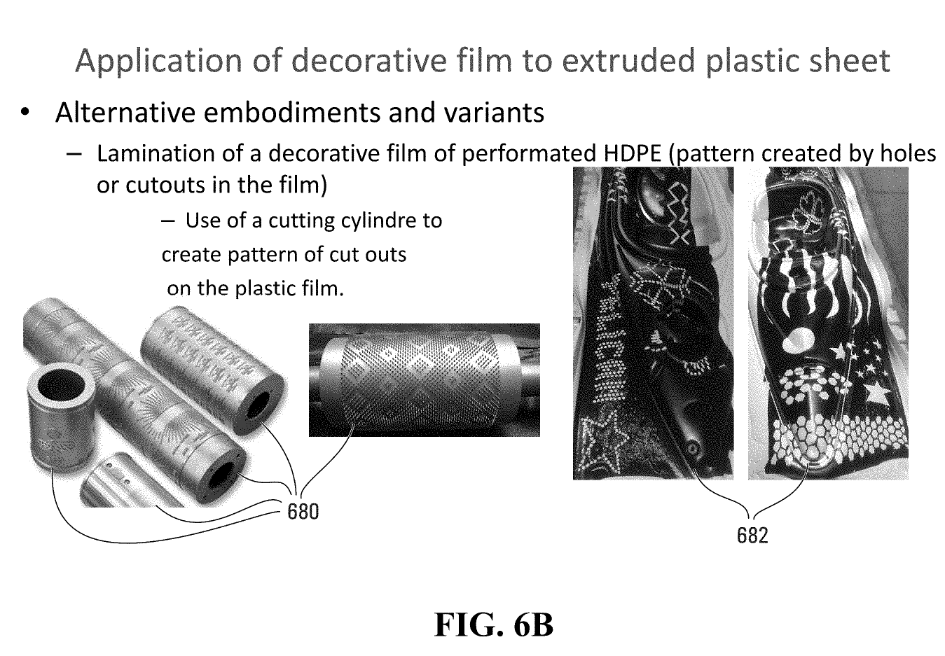

FIGS. 6A and 6B various examples of extruded plastic sheets with decorative effects resulting from the process described in the present document and variants thereof.

As depicted in a first example shown in FIG. 6A, the resulting sheet 600 may include an extruded plastic sheet layer 602; an adhesive layer 604; an ink layer 606 and a polyvinyl chloride (PVC) layer 608. In the example depicted, the combination of the adhesive layer 604; ink layer 606 and polyvinyl chloride (PVC) layer 608 has a thickness of about 6 mils (1 mil=0.001 inches).

As depicted in a second example shown in FIG. 6A, the resulting sheet 650 may include an extruded plastic sheet layer 620; a polyethylene (PE) layer 622; an adhesive layer 624; an ink layer 626 and a polypropylene (P) layer 628. In the example depicted, the combination of the polyethylene (PE) layer 622; adhesive layer 624; ink layer 626 and polypropylene (P) layer 628 has a thickness of about 3 mils (1 mil=0.001 inches).

It is to be appreciated that the examples of extruded plastic sheets with decorative effects shown in FIG. 6A have been set forth for the purpose of illustration only and that many alternative combinations will become apparent for the person skilled in the art in view of the present description.

FIG. 6B shows examples of extruded plastic sheets with decorative effects resulting from a variant of the process described in the present document. More specifically, as illustrated, different decorative effects may be achieved by adding one or more cutting cylinders to the systems shown in any of FIGS. 1A, 1B, 1C, 2A, 2B and 2C and feeding the plastic film through such one or more cutting cylinders prior to the plastic film being fed through the positioning members (e.g. 114, 116, 170, 150A, 150B) of the film application assembly. The cutting cylinder(s), specific examples of which are depicted in FIG. 6B and labelled 680, are configured for cutting a plastic film as it is fed through the cutting cylinder in order to create different graphical patterns. Non-limiting example of specific graphical patterns 682 that may be created using a cutting cylinder are depicted in FIG. 6B.

The extruded plastic sheet with decorative effects resulting from the process described in the present document may be used as is in different applications. For example, the plastic sheet may be cut out to form tobogganing carpets, also referred to as crazy carpets. Alternatively, the extruded plastic sheet may be thermoformed into different shapes or final products. For example, the sheets of plastic characterized by decorative effects may be thermoformed into pedal boats, kayaks, canoes, stand-up paddle boards or other similar watercraft products. They may also be thermoformed into recreational products, such as toboggans and pools, among many other possibilities. They may also be thermoformed into other types of outdoor articles, such as yard equipment (e.g. cabanas, storage bins, yard furniture and the like), among many other possibilities. Whether thermoformed or not, an advantage of the extruded plastic sheet resulting from the above-described process is to provide an esthetically appealing appearance to the consumer or user.

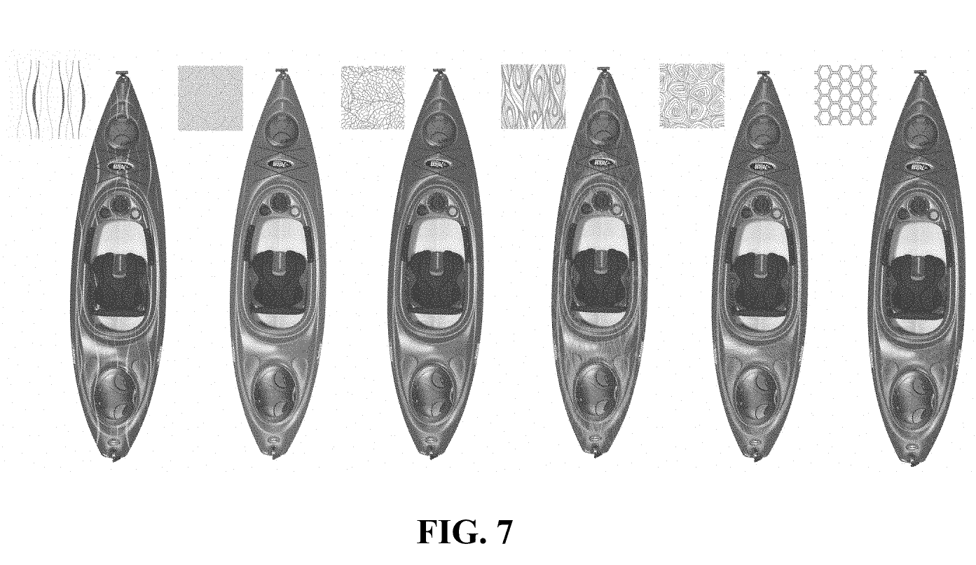

FIG. 7 shows kayaks manufactured using one or more extruded plastic sheets with decorative effects created using a process embodying aspects of the invention described in the present document.

More specifically, kayaks of the type depicted in FIG. 7 may be manufactured by molding two or more of the manufactured sheets of extrudable material using thermoforming to shape the two of more manufactured sheets into a kayak shape. In such process, one or more of the two or more of the manufactured sheets may have decorative effects created using a process embodying aspects of the invention described in the present document.

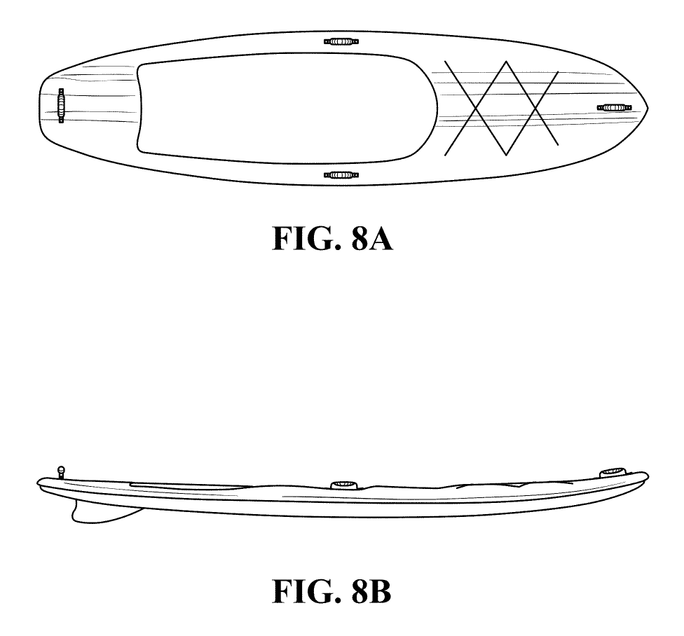

FIGS. 8A and 8B show top plan and side views respectively of a stand-up paddle board (SUP) manufactured using extruded plastic sheets created using a process embodying aspects of the invention described in the present document.

Although various embodiments have been illustrated, this was for the purpose of describing, but not limiting, the invention. Various modifications will become apparent to those skilled in the art and are within the scope of this invention, which is defined more particularly by the attached claims.

The foregoing is considered as illustrative only of the principles of the invention. Since numerous modifications and changes will become readily apparent to those skilled in the art in light of the present description, it is not desired to limit the invention to the exact examples and embodiments shown and described, and accordingly, suitable modifications and equivalents may be resorted to. It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

Although the present invention has been described in considerable detail with reference to certain embodiments thereof, variations and refinements are possible and will become apparent to the person skilled in the art in view of the present description. The invention is defined more particularly by the attached claims.

What is claimed is:

1. A system for creating an extruded sheet having a decorative surface effect, said system comprising:
a) an extruder module for providing a viscous material;
b) a feed block module positioned downstream from the extruder for receiving the viscous material and releasing a stream of viscous material;
c) a die positioned downstream from the feed block module for forming said stream of viscous material into a sheet of material;
d) a calander having a set of rolls positioned downstream from the die for smoothing the sheet of material after it is released by the die, in use the sheet of material released by the die being feed through the set of rolls of the calander in a specific sheet feed order, said set of rolls being configured for affecting a temperature of the sheet of material;
e) a film application assembly including modules configured to cooperate with the calander for applying a decorative plastic film to a surface of the sheet of material, wherein said film application assembly includes:
i) a support structure for holding a roll of the decorative plastic film; and
ii) a film feeding mechanism configured to direct the decorative plastic film to position a surface of the decorative plastic film opposite the surface of the sheet of material;
f) an output assembly downstream from the calander for directing the sheet of material to which the decorative plastic film has been applied towards an accumulation area.

2. A system as defined in claim 1, wherein said viscous material is a viscous plastic material.

3. A system as defined in claim 2, wherein the viscous plastic material is formed of at least one of: polyethylene (PE), polypropylene (PP), acetal, acrylic, nylon (polyamides), polystyrene, polyvinyl chloride (PVC), acrylonitrile butadiene styrene (ABS) and polycarbonate.

4. A system as defined in claim 2, wherein the viscous plastic material is formed of high density polyethylene (HDPE).

5. A system as defined in claim 2, wherein the film feeding mechanism includes positioning members for directing the decorative plastic film between adjacent rolls in the set of rolls of the calander, the adjacent rolls being configured to urge the surface of the decorative plastic film toward the opposed surface of the sheet of material to bond the decorative plastic film to the sheet of material.

6. (canceled)

7. A system as defined in claim 2, wherein the film feeding mechanism includes pressure rolls positioned downstream from the calander to urge the surface of the decorative plastic film toward the opposed surface of the sheet of material to bond the decorative plastic film to the sheet of material.

8. A system as defined in claim 1, wherein the film application assembly further includes modules for heating the decorative plastic film to cause the decorative plastic film to be thermally bonded to the sheet of material.

9. A system as defined in claim 1, wherein the modules of the film application assembly are configured to cause the decorative plastic film to be chemically bonded to the sheet of material.

10. A system as defined in claim 2, wherein the film feeding mechanism is configured to cooperate with the calander to direct the decorative plastic film through the rolls of the calander in a specific film feed order.

11. (canceled)

12. As system as defined in claim 10, wherein the specific sheet feed order and the specific film feed order are characterized by different sequences of pairs of adjacent rolls of the calander between which the sheet of material and the plastic film are fed.

13. As system as defined in claim 12, wherein a specific sequence of pairs of adjacent rolls of the calander between which the sheet of material is fed includes at least one pair of adjacent rolls which is omitted from the specific sequence of pairs of adjacent rolls between which the plastic film is fed.

14. (canceled)

15. A system as defined in claim 2, wherein at least some rolls in said set of rolls are configured for cooling the temperature of the sheet of material to no more than between about 250° F. and about 450° F. to allow the decorative plastic film to thermally bond with the sheet of material.

16. (canceled)

17. A system as defined in claim 1, wherein at least some rolls in said set of rolls have a textured outer surface configured for imparting a three-dimensional texture on the surface of the sheet of material to which the decorative plastic film is applied, textured outer surface of the at least some rolls including projections for creating the three-dimensional texture on the surface of the sheet of material.

18. A system as defined in claim 17, wherein the decorative plastic film includes one or more graphical elements and wherein the textured outer surface of the rolls is configured to complement the one or more graphical elements of the decorative plastic film.

19. (canceled)

20. A system as defined in claim 1, wherein the decorative plastic film is comprised at least in part of one of polyvinyl chloride (PVC), polyethylene (PE), Poly(methyl methacrylate) (PMMA), acrylic, Polyvinylidene difluoride (PVDF) and polypropylene (PP).

21.-26. (canceled)

27. A system as defined in claim 1, wherein the decorative plastic film includes an ink-based decorative element.

28. A system as defined in claim 27, wherein the ink-based decorative element covers a portion of the decorative plastic film and wherein an other portion of the decorative plastic film is characterized by an absence of ink-based decorative elements.

29.-37. (canceled)

38. A system as defined in claim 1, wherein the output assembly includes cutting elements configured for cutting the sheet of material into individual sheet portions.

39. A system as defined in claim 38, wherein the decorative plastic film including a specific graphical pattern, and wherein the output assembly includes optical sensors configured for gathering data conveying graphical information associated with the sheet of material to which the decorative plastic film has been applied and a processing module programmed for:
a) processing the data conveying graphical information associated with the sheet of material to which the decorative plastic film has been applied to detect a position of the specific graphical pattern;
b) controlling the cutting elements at least in part based on the position of the specific graphical pattern.

40. A system as defined in claim 39, wherein the processing module programmed for controlling the cutting elements at least in part based on the detected position of the specific graphical pattern to prevent cutting through the specific graphical pattern when cutting the sheet.

41. (canceled)

42. (canceled)

43. A system as defined in claim 1, wherein the film application assembly further comprises modules for applying one or more specific treatments to the decorative plastic film prior to positioning the decorative plastic film opposite the surface of the sheet of material.

44.-48. (canceled)

49. A system as defined in claim 43, wherein the modules of the film assembly are configured to heat the decorative plastic film to increase a level of adhesion between the decorative plastic film and the sheet of material.

50. A roll of decorative plastic film for creating a decorative surface effect on an extruded plastic sheet, said roll of decorative plastic film being configured for lamination of the extruded sheet of plastic material, said roll of decorative plastic film comprising:
a) a film layer having a first surface and a second surface;
b) an ink layer including an ink composition applied to the first surface of said film layer to convey a specific decorative effect.

51. A roll of decorative plastic film as defined in claim 50, wherein the film layer of the decorative plastic film is comprised at least in part of one of polyvinyl chloride (PVC), polyethylene (PE), Poly(methyl methacrylate) (PMMA), acrylic, Polyvinylidene difluoride (PVDF) and polypropylene (PP).

52.-73. (canceled)

74. A roll of decorative plastic film as defined in claim 50, wherein said film layer is a first film layer, said roll further comprising a second film layer positioned opposite the first film layer and encapsulating said ink layer.

75.-83. (canceled)

84. A roll of decorative plastic film as defined in claim 50, wherein the specific decorative effect conveyed by said ink-layer includes one of a carbon-finish, waves, camouflage and wood paneling.

85. (canceled)

86. (canceled)

87. (canceled)

88. A process for creating an extruded sheet having a decorative surface effect, said process comprising:
a) providing a viscous material;
b) extruding the viscous material using an extruder and releasing a stream of viscous material through a feedblock module;
c) forming the stream of viscous material into a sheet of material using a die positioned downstream from the feed block module;
d) smoothing the sheet of material after it is released by the die using a calander having a set of rolls positioned downstream from the die, wherein smoothing the sheet of material including feeding the sheet of material through the set of rolls of the calander in a specific sheet feed order;
e) cooling the sheet of material as it feed through the calendar to a specific temperature range;
f) applying a decorative plastic film to a surface of the sheet of material using a film application assembly including modules configured to cooperate with the calander, wherein applying the decorative plastic film to the surface of the sheet of material includes directing the decorative plastic film to position a surface of the decorative plastic film opposite the surface of the sheet of material;
g) directing the sheet of material to which the decorative plastic film has been applied towards an accumulation area.

89.-102. (canceled)

103. A process as defined in claim 88, further comprising cutting the sheet of material into individual sheet portions.

104. A process as defined in claim 103, wherein the decorative plastic film including a specific graphical pattern, said process comprising:
a) gathering image data conveying graphical information associated with the sheet of material to which the decorative plastic film has been applied;
b) processing the data conveying graphical information associated with the sheet of material to which the decorative plastic film has been applied to detect a position of the specific graphical pattern;
c) controlling cutting elements at least in part based on the detected position of the specific graphical pattern when cutting the sheet of material into individual sheet portions to avoid cutting through the specific graphical pattern.

105. (canceled)

106. A process as defined in claim 88, said process further comprising:
a) providing at least two additional flows of viscous material;
b) combining the flow of viscous material with the at least two additional flows of viscous material to form the released stream of viscous material, wherein the stream of viscous material released by the feed block module is a co-extruded stream having at least three layers.

107.-111. (canceled)

112. A process for manufacturing a kayak having a decorated surface, said process comprising
molding two or more manufactured sheets of extruded material using thermoforming to shape the two of more manufactured sheets into a kayak shape, at least one of the two or more of the manufactured sheets having decorative surface effects created using a process defined in claim 88.

113. A plastic article manufactured at least in part using a sheet of extruded material having decorative surface effects created at least in part by a process defined in claim 88.

114.-117. (canceled)
